(19) United States
(12) Patent Application Publication
(10) Pub. No.: US 2025/0335789 A1
(43) Pub. Date: Oct. 30, 2025

(54) METHOD AND SYSTEM FOR FACILITATING PREDICTION ON A GRAPH

(71) Applicant: Armand E. Prieditis, MCKINLEYVILLE, CA (US)

(72) Inventor: Armand E. Prieditis, MCKINLEYVILLE, CA (US)

(21) Appl. No.: 18/648,473

(22) Filed: Apr. 28, 2024

(51) Int. Cl. G06N 5/022

(52) U.S. Cl. CPC G06N 5/022

(57) ABSTRACT

Embodiments of the subject matter facilitate prediction on a directed graph comprising nodes and edges. In one embodiment of the subject matter, prediction is over the entire graph. In another embodiment of the subject matter, prediction is for each node in the graph. The prediction can be categorical or a vector of real values (i.e., multivariate). Embodiments of the subject matter are not sensitive to the order in which the graph's nodes and edges are presented during training or prediction: they are invariant to rotations, translations, reflections, and permutations of the graph. Embodiments of the subject matter facilitate prediction on both directed and undirected graphs.

### BACKGROUND

### Field

The subject matter relates to prediction associated with a graph.

### Related Art

A graph comprises a non-empty set of nodes and a non-empty set of edges. A node corresponds to an entity and an edge corresponds to a connection between one entity and another. For example, a molecule can be represented as a graph with atoms as nodes and bonds as edges between pairs of atoms. A social network can be represented as a graph with people as nodes and relationships as edges between pairs of people who know each other.

A graph can be undirected or directed. For example, if the nodes represent people at a party, and an edge between two people corresponds to a handshake between the two people, then the graph is undirected because a handshake is symmetric. In contrast, if an edge corresponds to one person owing money to a second person, then the graph is directed, because owing money is not necessarily symmetric. Theoretically, all graphs can be considered as directed because an undirected graph can be represented as a graph where all the edges are symmetric (i.e., an edge between node A and node B implies an between node B and node A).

Graphs have many practical applications including in bioinformatics, drug development, search engines, document retrieval, chemo-informatics, social network analysis, urban computing, and cyber-security. One application is predicting a property of the graph. For example, predicting whether a molecule is toxic can reduce the time and cost of drug development. Without such predictions, testing just a few thousand molecules for a dozen toxic effects can cost millions of dollars.

Classical chemical and genetic screens, which are heavily used in drug screening, suffer from extremely low accuracy (1%-3% hit rates). Machine learning might offer a more accurate and lower cost and time way to predict properties of molecules but a machine learning method expects a fixed-order and fixed-length vector as input not a molecule represented as a graph. This is because the nodes and edges of graphs can be provided in any order and a graph can be of any size, with any number of nodes and edges.

To address the challenge of representing a graph as a fixed-length vector, Graph Convolutional Networks (GCNs) were developed. A GCN is a deep neural network that aggregates the information at each node's set of neighbors and then linearly combines that aggregation with a single-layer neural network. Aggregations can include sum, mean, min, and max.

The GCN then repeats the same process, each time using the resulting aggregation as an input for the next stage, until a desired vector size is achieved, which can then be fed into a final neural network. A GCN is trained with backpropagation.

GCNs suffer from several major problems. First, all nodes eventually converge to the same value in the limit of aggregations and linear combinations. This is because the aggregations and linear combinations tend to average the information over all nodes with each update. This averaging destroys locality, which in turn reduces accuracy.

Second, GCNs leverage only one machine learning algorithm to learn the coefficients for each layer of the neural network: back-propagation. GCNs do not leverage other successful machine learning methods, which were developed and honed over decades and which could result in higher accuracy.

Third, because a GCN feeds the output of one aggregation and linear combination into the next, it blurs the distinction between nodes that are close to each other in terms of the number of edges and nodes that are farther away from each other. Blurring of these distance-dependent effects can also result in lower accuracy.

Fourth, a GCN does not natively learn from a graph—the graph is first converted in a fixed-length vector, which is then fed into a final neural network.

Hence, what is needed is a graph-native method and a system for transforming a graph into a vector so that the vector can be input into any machine learning method, while maintaining locality and distance-dependent effects.

### SUMMARY

Embodiments of the subject matter facilitate prediction on a directed graph comprising nodes and edges. In one embodiment of the subject matter, prediction is over the entire graph. In another embodiment of the subject matter, prediction is for each node in the graph. The prediction can be categorical or a vector of real values (i.e., multivariate).

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGURES

FIGS. 1-4 present example systems for facilitating prediction on a graph.

In the figures, like reference numerals refer to the same figure elements.

### DETAILED DESCRIPTION

In embodiments of the subject matter, a directed graph comprises a set of nodes with associated attributes x, where xᵢ corresponds to one or more attributes associated with the i^{th} node in the graph, and a set of edges with associated attributes e, where e_{i,j} corresponds to one or more attributes associated with an edge between the i^{th} node in the graph and j^{th} node in the graph. For convenience of notation, nodes are assumed be labeled by integers. However, any discrete labeling system can be used.

For example, a molecule can be represented by a graph where the nodes are atoms and the edges correspond to between atoms. The value x could correspond to atom properties (e.g. atomic number, atomic mass) in a molecule the value e could correspond to the strength of a bond (e.g., single, double, triple).

In the internet, an edge could correspond to the click-through rate for a link to another website from a particular website, where websites are nodes in a graph. An edge can also correspond to the probability of a connection between one node (a row in the node matrix) and another node (a column in the node matrix). In this example, xᵢ could correspond to website properties (e.g., the frequency of words at a website) for the i^{th} website.

The graph is assumed to contain at least two nodes connected by an edge. The value xᵢ and the value e_{i,j} can be real-valued vectors or categorical variables.

One embodiment of the subject matter determines a prediction (output, target) o∈O that maximizes the following expression:

$$p ( o ) {\prod }_{i = 1}^{k} p ( {x}_{i} \vert o ) {\prod }_{j ∈ n ( i )} p ( {e}_{i , j} \vert {x}_{i} , {x}_{j} , o ) ,$$

where O is a set of categories (classes), p(o) is the probability of o, k is the number of nodes in the graph, p(xᵢ|o) is the probability of xᵢ given o, n(i) is the set of neighbors of node i, and p(e_{i,j}|xᵢ, xⱼ, o) is the probability of edge e_{i,j} given xᵢ, xⱼ, and o. Note that this edge is directed from xᵢ to xⱼ.

This type of prediction is called graph classification. For example, graph classification might involve predicting whether a molecule passes through the blood brain barrier. For an image application, graph classification might involve determining whether an image contains a dog. When the target is not given in the training data, the process of learning is called clustering or segmentation, which can be used to discover groups in the training data. Graph classification can be used to determine a group for an unseen graph.

Embodiments of the subject matter can use an equivalent and simpler form: choose an o∈O that maximizes:

$$l ( o ) + {\sum }_{i = 1}^{k} [ l ( {x}_{i} \vert o ) + {\sum }_{j ∈ n ( i )} l ( {e}_{i , j} \vert {x}_{i} , {x}_{j} , o ) ] ,$$

where l(o) is the log of the probability of o, k is the number of nodes in the graph, l(xᵢ|o) is the log of the probability of xᵢ given o, n(i) is the set of neighbors of node i, and (e_{i,j}|xᵢ, xⱼ, o) is the log of the probability of edge e_{i,j} given xᵢ, xⱼ, and o. Since this form contains sums instead of products, the resulting expression is simpler to compute on computing systems. Not only that, but dealing directly with probabilities can lead to underflow is most computing systems, which is not the case with this form.

Various machine learning methods, current or to be invented, can be used to learn the model, which comprises p(o), p(xᵢ|o), and p(e_{i,j}|xᵢ, xⱼ, o). For example, XGBoost could be used to learn the model when the target o is given in the training data (i.e., supervised learning). Each row in the training data can comprise the target o together with the graph: xᵢ for each node in the row, and the triples e_{i,j}, xᵢ, and xⱼ, for all neighbors xᵢ, as connected by edge e_{i,j}. In short, each row in the training data comprises a graph, its corresponding targets, and its corresponding node and edge attributes.

When the target o is not given in the training data (i.e., unsupervised learning), methods such as Expectation-Maximization (EM) can be used to learn the model. Note that the prediction method is the same regardless of whether the target o is missing in the training data.

When the target o is a real-valued vector, the prediction is called graph regression. In this case, it is not possible to enumerate the set of all real-value vectors O and determine a vector o that maximizes:

$$l ( o ) + {\sum }_{i = 1}^{k} [ l ( {x}_{i} \vert o ) + {\sum }_{j ∈ n ( i )} l ( {e}_{i , j} \vert {x}_{i} , {x}_{j} , o ) ] .$$

This is because there are an infinite number of real-valued vectors in O.

However, when l(o) is log of a multivariate Gaussian distribution, l(xᵢ|o) is the log of a conditional multivariate Gaussian distribution, and l(e_{i,j}|xᵢ, xⱼ, o) is the log of a conditional multivariate Gaussian distribution, then a vector o that maximizes

$$l ( o ) + {\sum }_{i = 1}^{k} [ l ( {x}_{i} \vert o ) + {\sum }_{j ∈ n ( i )} l ( {e}_{i , j} \vert {x}_{i} , {x}_{j} , o ) ]$$

can be determined exactly.

A multivariate Gaussian distribution is defined by a mean vector μ and a covariance matrix Σ and is associated with a probability distribution function,

$$\frac{1}{\sqrt{\vert 2 π \sum \vert}} exp ( - \frac{1}{2} [ {( x - μ )}^{T} {\sum }^{- 1} ( x - μ ) ] ) ,$$

where |2πΣ| is the determinant of 2πΣ, x is an input, (x−μ)^{T} is the transpose of (x−μ), and Σ⁻¹ is the matrix inverse of Σ.

Furthermore, a conditional multivariate Gaussian distribution is defined by a mean vector

$${μ}_{a} + {\sum }_{c} {\sum }_{b}^{- 1} ( {x}_{b} - {μ}_{b} )$$

and covariance matrix

$${\sum }_{a} - {\sum }_{c} {\sum }_{b}^{- 1} {\sum }_{c}^{T} ,$$

where x is block partitioned as

$$[ \begin{matrix}{x}_{a} \\ {x}_{b}\end{matrix} ] ,$$

μ is block partitioned as

$$[ \begin{matrix}{μ}_{a} \\ {μ}_{b}\end{matrix} ] ,$$

and Σ is block portioned as

$$[ \begin{matrix}{\sum }_{a} & {\sum }_{c} \\ {\sum }_{b}^{T} & {\sum }_{b}\end{matrix} ] .$$

Here, the distribution is conditioned on x_{b}.

A matrix interpreted as a partitioned matrix can be visualized as the original matrix with a collection of horizontal and vertical lines, which break it up, or partition it, into a collection of smaller matrices. For example, the 3×4 matrix presented below is divided by horizontal and vertical lines into four blocks: the top-left 2×3 block, the top-right 2×1 block, the bottom-left 1×3 block, and the bottom-right 1×1 block.

$$[ \begin{matrix}{a}_{11} & {a}_{12} & {a}_{13} & \vert & {b}_{1} \\ {a}_{21} & {a}_{22} & {a}_{23} & \vert & {b}_{2} \\ - & - & - & \vert & - \\ {c}_{1} & {c}_{2} & {c}_{3} & \vert & d\end{matrix} ]$$

Any matrix may be interpreted as a partitioned matrix in one or more ways, with each interpretation defined by how its rows and columns are partitioned.

The form of these log probability functions is as follows (constants that do not affect maximizing over o are removed):

l(o)=(o−μ)^{T}Σ⁻¹(o−μ), where μ is the mean vector of a multivariate Gaussian distribution and Σ is the covariance matrix of a multivariate Gaussian, where Σ⁻¹ is the matrix inverse of Σ and y^{T} is the matrix transpose of y. Multiple different methods can be used to compute Σ⁻¹, including approximation methods and exact methods such as Gaussian Elimination. Note that μ and Σ can be learned from training data. For example, μ can be the sample mean over all o in the training data and Σ can be the sample covariance matrix over all o in the training data. However, μ and Σ can also be directly supplied by a human expert or some other process.

$$l ( {x}_{i} \vert o ) = {( {x}_{i} - [ {\dot{μ}}_{a} + {\dot{\sum }}_{c} {\dot{\sum }}_{b}^{- 1} ( o - {\dot{μ}}_{b} ) ] )}^{T} {( {\dot{\sum }}_{a} - {\dot{\sum }}_{c} {\dot{\sum }}_{b}^{- 1} {\dot{\sum }}_{b}^{T} )}^{- 1} ( {x}_{i} - [ {\dot{μ}}_{a} + {\dot{\sum }}_{c} {\dot{\sum }}_{b}^{- 1} ( o - {\dot{μ}}_{b} ) ] ) ,$$

here \dot{μ} and \dot{Σ} define a multivariate Gaussian distribution over

$$[ \begin{matrix}{x}_{i} \\ o\end{matrix} ] ,$$

xᵢ corresponds to information associated with an i^{th} node in the graph, xⱼ corresponds to information associated with a j^{th} node in the graph, e_{i,j} corresponds to information associated with a directed edge from the i^{th} node in the graph to a j^{th} node in the graph \dot{μ}_{b} is a subvector of \dot{μ} associated with a mean of o (i.e., \dot{μ} is block portioned into

$$( [ \begin{matrix}{\dot{μ}}_{a} \\ {\dot{μ}}_{b}\end{matrix} ] ) ,$$

\dot{μ}ₐ is a subvector of \dot{μ} associated with a mean of xᵢ, \dot{Σ}_{c} is a submatrix of \dot{Σ} associated with a covariance between xᵢ and o, \dot{Σ}_{b} is a submatrix of \dot{Σ} associated with a covariance of o, and \dot{Σ}ₐ is a submatrix of \dot{Σ} associated with a covariance of xᵢ. The term submatrix and subvector refer to a specific partition of the original matrix and vector, respectively.

$$l ( {e}_{i , j} \vert {x}_{i} , {x}_{j} , o ) = {( {e}_{i , j} - [ {\ddot{μ}}_{a} + {\ddot{\sum }}_{c} {\ddot{\sum }}_{b}^{- 1} ( [ \begin{matrix}{x}_{i} \\ {x}_{j} \\ o\end{matrix} ] - {\ddot{μ}}_{b} ) ] )}^{T} {( {\ddot{\sum }}_{a} - {\ddot{\sum }}_{c} {\ddot{\sum }}_{b}^{- 1} {\ddot{\sum }}_{b}^{T} )}^{- 1} ( {e}_{i , j} - [ {\ddot{μ}}_{a} + {\ddot{\sum }}_{c} {\ddot{\sum }}_{b}^{- 1} ( [ \begin{matrix}{x}_{i} \\ {x}_{j} \\ o\end{matrix} ] - {\ddot{μ}}_{b} ) ] ) ,$$

where \ddot{μ} and \ddot{Σ} define a multivariate Gaussian distribution over

$$[ \begin{matrix}{e}_{i , j} \\ {x}_{i} \\ {x}_{j} \\ o\end{matrix} ] ,$$

xᵢ corresponds to information associated with an i^{th} node in the graph, xⱼ corresponds to information associated with a j^{th} node in the graph, e_{i,j} corresponds to information associated with a directed edge from the i^{th} node in the graph to a j^{th} node in the graph, \ddot{Σ}_{c} is a submatrix of \ddot{Σ} associated with a covariance between e_{i,j} and

$$[ \begin{matrix}{x}_{i} \\ {x}_{j} \\ o\end{matrix} ] ,$$

\ddot{Σ}_{b} is a submatrix of \ddot{Σ} associated with a covariance of

$$[ \begin{matrix}{x}_{i} \\ {x}_{j} \\ o\end{matrix} ] ,$$

\ddot{Σ}ₐ is a submatrix of \ddot{Σ} associated with a covariance of e_{i,j}, \ddot{μ}_{b} is a subvector of \ddot{μ} associated with a mean of

$$[ \begin{matrix}{x}_{i} \\ {x}_{j} \\ o\end{matrix} ] ,$$

\ddot{μ}ₐ is a subvector of \ddot{μ} associated with a mean of e_{i,j},

$${( {\ddot{\sum }}_{c} {\ddot{\sum }}_{b}^{- 1} )}^{′}$$

is a submatrix of

$${\ddot{\sum }}_{c} {\ddot{\sum }}_{b}^{- 1}$$

associated with o but not

$$[ \begin{matrix}{x}_{i} \\ {x}_{j}\end{matrix} ]$$

is a submatrix of

$${\ddot{\sum }}_{c} {\ddot{\sum }}_{b}^{- 1}$$

associated with

$$[ \begin{matrix}{x}_{i} \\ {x}_{j}\end{matrix} ]$$

but not o.

Note that μ, Σ, \dot{μ}, \dot{Σ}, \ddot{μ}, \ddot{Σ} can all be learned from training data, where each row in the training data comprises a graph and its associated output (target). Standard methods can be used to determine these means and covariances, some exact and others approximate. Embodiments of the subject matter do not distinguish between the two.

A vector o that maximizes

$$l ( o ) + {\sum }_{i = 1}^{k} [ l ( {x}_{i} \vert o ) + {\sum }_{j ∈ n ( i )} l ( {e}_{i , j} \vert {x}_{i} , {x}_{j} , o ) ]$$

is equal to

$$- {( S + {\sum }_{i = 1}^{k} [ {\dot{A}}^{T} \dot{S} \dot{A} + {\sum }_{j ∈ n ( i )} {\ddot{A}}^{T} \ddot{S} \ddot{A} ] )}^{- 1} ( SB + {\sum }_{i = 1}^{k} [ {\dot{A}}^{T} \dot{S} \dot{B} + {\sum }_{j ∈ ( i )} {\ddot{A}}^{T} \ddot{S} \ddot{A} ] ) .$$

The terms \dot{A}, \dot{S}, Ä, \ddot{S}, B, \dot{B}, and \ddot{B} will be described shortly, after providing a few insights behind this expression.

First, note that l(o)=(o−μ)^{T}Σ⁻¹(o−μ) can be equivalently expressed as involving a linear combination as in (Ao+B)^{T}S(Ao+B), where S=Σ⁻¹, A=I, B=−μ, and where I is the identity matrix. Given this linear combination form, the o that maximizes this expression is equal to −(A^{T}SA)⁻¹(A^{T}SB), which can be simplified to −(S)⁻¹(SB), since A=I, and then further simplified to −B. So, the value of o at which l(o) is maximized is equal to μ, which is satisfying mathematically but obvious because a single multivariate Gaussian distribution peaks in probability at the mean value.

It turns out that for a sum of n multivariate Gaussians (with constants not involved in maximization over o removed) of the form

$${\sum }_{i = 1}^{n} {( {A}_{i} o + {B}_{i} )}^{T} {S}_{i} ( {A}_{i} o + {B}_{i} ) ,$$

the value of o where that form is maximized is equal to:

$$- {( {\sum }_{i = 1}^{n} {A}_{i}^{T} {S}_{i} {A}_{i} )}^{- 1} ( {\sum }_{i = 1}^{n} {A}_{i}^{T} {S}_{i} {B}_{i} ) .$$

Using the aforementioned method to determine o exactly, the variables \dot{A}, \dot{B}, \dot{S}, Ä, \ddot{B}, and \ddot{S} can be set to the following:

$$\begin{matrix}\dot{A} = - {\dot{\sum }}_{c} {\dot{\sum }}_{b}^{- 1} , \dot{B} = {x}_{i} - [ {\dot{μ}}_{a} - {\dot{\sum }}_{c} {\dot{\sum }}_{b}^{- 1} {\dot{μ}}_{b} ] and \dot{S} = {( {\dot{\sum }}_{a} - {\dot{\sum }}_{c} {\dot{\sum }}_{b}^{- 1} {\dot{\sum }}_{c}^{T} )}^{- 1} . \\ \ddot{A} = - {( {\ddot{\sum }}_{c} {\ddot{\sum }}_{b}^{- 1} )}^{′} , \ddot{B} = {e}_{i , j} - [ {\ddot{μ}}_{a} + {( {\ddot{\sum }}_{c} {\ddot{\sum }}_{b}^{- 1} )}^{″} [ \begin{matrix}{x}_{i} \\ {x}_{j}\end{matrix} ] - ( {\ddot{\sum }}_{c} {\ddot{\sum }}_{b}^{- 1} ) {μ}_{b} ] ,\end{matrix}$$

$$and \ddot{S} = {( {\ddot{\sum }}_{a} - {\ddot{\sum }}_{c} {\ddot{\sum }}_{b}^{- 1} {\ddot{\sum }}_{C}^{T} )}^{1} ,$$

where

$${( {\ddot{\sum }}_{c} {\ddot{\sum }}_{b}^{- 1} )}^{′}$$

is a submatrix of

$${\ddot{\sum }}_{c} {\ddot{\sum }}_{b}^{- 1}$$

associated with o and

$${( {\ddot{\sum }}_{c} {\ddot{\sum }}_{b}^{- 1} )}^{″}$$

is a submatrix of

$${\ddot{\sum }}_{c} {\ddot{\sum }}_{b}^{- 1}$$

associated with

$$[ \begin{matrix}{x}_{i} \\ {x}_{j}\end{matrix} ] .$$

As mentioned, the model comprising the aforementioned mean vectors and covariance matrices can be learned from training data, where each row of the training data comprises a graph and the target output. For example, each molecule in the training data might comprise a thousand different real-valued properties of that molecule. Once the model is learned from this data, it is possible to predict those thousand properties all at once for a new graph with embodiments of the subject matter.

Note that embodiments of the subject matter are not sensitive to the order in which the graph's nodes and edges are presented during training or prediction: they are invariant to rotations, translations, reflections, and permutations of the graph. Embodiments of the subject matter facilitate prediction on both directed and undirected graphs by treating an undirected graph as a directed one with symmetric edges with the same value(s).

Regression is more general than classification in that any classification problem can be transformed to a regression problem (e.g., with one-hot encoding), but not every regression problem can be transformed to a classification problem. Fundamentally, classification is about predicting a label and regression is about predicting a quantity, though in embodiments of the subject matter regression is about predicting one or more quantities. A simple way to distinguish the two is as follows: if the output of the classifier is discrete (e.g., integer values from 1 to 10), it's classification; if the output is continuous (e.g., values between 0 and 1), it's regression. The two are fundamentally different from each other because a label is not the same as a quantity.

Another embodiment of the subject matter determines a prediction (output, target) oᵢ∈O at each node i that maximizes the following expression: p(oᵢ)p(xᵢ|oᵢ)Π_{j∈n(i)}p(e_{i,j}|xᵢ, xⱼ, oᵢ). This type of prediction is called node classification and is for each node in a graph rather than over the whole graph. For images, this type of prediction is called pixel classification. An equivalent form of p(oᵢ)p(xᵢ|oᵢ)Π_{j∈n(i)}p(e_{i,j}|xᵢ, xⱼ, oᵢ) is l(oᵢ)+l(xᵢ|oᵢ)+Σ_{j∈n(i)}l(e_{i,j}|xᵢ, xⱼ, oᵢ). Hence, another embodiment of the subject matter determines a prediction oᵢ∈O at each node i that maximizes the following expression: l(oᵢ)+l(xᵢ|oᵢ)+Σ_{j∈n(i)}l(e_{i,j}|xᵢ, xⱼ, oᵢ).

When oᵢ is categorical but not given in the training data (i.e., nodes are not explicitly labeled), this type of prediction is called node clustering or node segmentation or semantic segmentation. Note that the prediction method is the same whether oᵢ is given in the training data.

Similar to graph regression, embodiments of the subject matter can facilitate node regression, which has an exact solution at each node with

$${o}_{i} = to - {( S + [ {\dot{A}}^{T} \dot{S} \dot{A} + {\sum }_{j ∈ n ( i )} {\ddot{A}}^{T} \ddot{S} \ddot{A} ] )}^{- 1} ( SB + {\sum }_{i = 1}^{k} [ {\dot{A}}^{T} \dot{S} \dot{B} + {\sum }_{j ∈ ( i )} {\ddot{A}}^{T} \ddot{S} \ddot{B} ] ) ,$$

$$Where :$$

$$\begin{matrix}S = {\sum }^{- 1} and B = - μ . \\ \dot{A} = - {\dot{\sum }}_{c} {\dot{\sum }}_{b}^{- 1} , \dot{B} = {x}_{i} - [ {\dot{μ}}_{a} - {\dot{\sum }}_{c} {\dot{\sum }}_{b}^{- 1} {\dot{μ}}_{b} ] , and \dot{S} = {( {\dot{\sum }}_{a} - {\dot{\sum }}_{c} {\dot{\sum }}_{b}^{- 1} {\dot{\sum }}_{c}^{T} )}^{- 1} . \\ \ddot{A} = - {( {\ddot{\sum }}_{c} {\ddot{\sum }}_{b}^{- 1} )}^{′} , \ddot{B} = {e}_{i , j} - [ {\ddot{μ}}_{a} + {( {\ddot{\sum }}_{c} {\ddot{\sum }}_{b}^{- 1} )}^{″} [ \begin{matrix}{x}_{i} \\ {x}_{j}\end{matrix} ] - ( {\ddot{\sum }}_{c} {\ddot{\sum }}_{b}^{- 1} ) {μ}_{b} ] ,\end{matrix}$$

$$and \ddot{S} = {( {\ddot{\sum }}_{a} - {\ddot{\sum }}_{c} {\ddot{\sum }}_{b}^{- 1} {\ddot{\sum }}_{c}^{T} )}^{- 1} , where {( {\ddot{\sum }}_{c} {\ddot{\sum }}_{b}^{- 1} )}^{′}$$

is that portion of the matrix

$${\ddot{\sum }}_{c} {\ddot{\sum }}_{b}^{- 1}$$

associated with o but not

$$[ \begin{matrix}{x}_{i} \\ {x}_{j}\end{matrix} ] , and {( {\ddot{\sum }}_{c} {\ddot{\sum }}_{b}^{- 1} )}^{″}$$

is that portion of the matrix

$${\ddot{\sum }}_{c} {\ddot{\sum }}_{b}^{- 1}$$

associated with

$$[ \begin{matrix}{x}_{i} \\ {x}_{j}\end{matrix} ]$$

but not o.

Note that the above definitions appear to be similar to the ones for graph regression. Instead, all of the mean vectors and covariance matrices refer to node regression rather than graph regression. That is, they are learned from rows of training data comprising nodes and their corresponding targets rather than graphs and their corresponding targets.

As with graph regression, node regression is more general than node classification. That is, any node classification problem can be transformed into a node regression problem with a suitable encoding (e.g., one-hot encoding), but not every node regression problem can be transformed into a node classification problem.

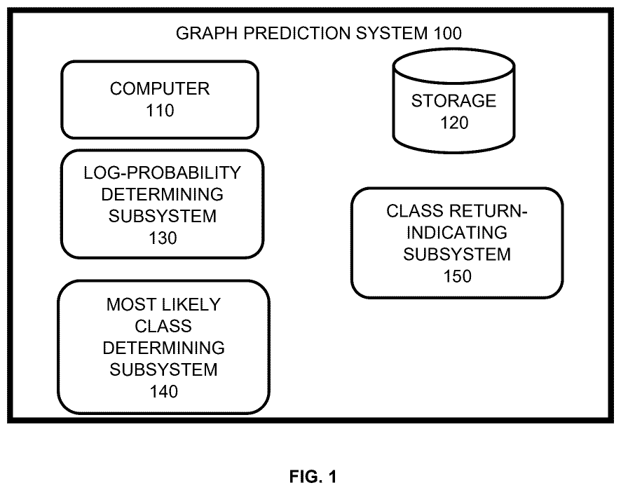

FIG. 1 shows an example graph prediction system 100 in accordance with an embodiment of the subject matter. Graph prediction system 100 is an example of a system implemented as a computer program on one or more computers in one or more locations (shown collectively as computer 110), with one or more storage devices (shown collectively as storage 120), in which the systems, components, and techniques described below can be implemented.

During operation, graph prediction system 100 determines a log probability with log-probability determining subsystem 130. Log-probability determining subsystem 130 determines for every o∈O the expression

$$l ( o ) + {\sum }_{i = 1}^{k} [ l ( {x}_{i} \vert o ) + {\sum }_{j ∈ n ( i )} l ( {e}_{i , j} \vert {x}_{i} , {x}_{j} , o ) ] ,$$

where l(o) is the log of the probability of o, k is the number of nodes in the graph, l(xᵢ|o) is the log of the probability of xᵢ given o, n(i) is the set of neighbors of node i, and (e_{i,j}|xᵢ, xⱼ, o) is the log of the probability of a (directed) edge e_{i,j} given xᵢ, xⱼ, and o.

Next, graph prediction system 100 determines a most likely class with most likely class determining subsystem 140. Specifically, most likely class determining subsystem 140 Specifically, most likely class determining subsystem 140 determines an o∈O that maximizes the previously determined expression

$$l ( o ) + {\sum }_{i = 1}^{k} [ l ( {x}_{i} \vert o ) + {\sum }_{j ∈ n ( i )} l ( {e}_{i , j} \vert {x}_{i} , {x}_{j} , o ) ] .$$

Subsequently, graph prediction system 100 returns a result that indicates the o∈O that maximizes the previously determined expression

$$l ( o ) + {\sum }_{i = 1}^{k} l ( {x}_{i} \vert o ) {\sum }_{j ∈ n ( i )} l ( {e}_{i , j} \vert {x}_{i} , {x}_{j} , o )$$

with class return indicating subsystem 150. Graph prediction system 100 thus returns a result that indicates the most likely class for a particular graph.

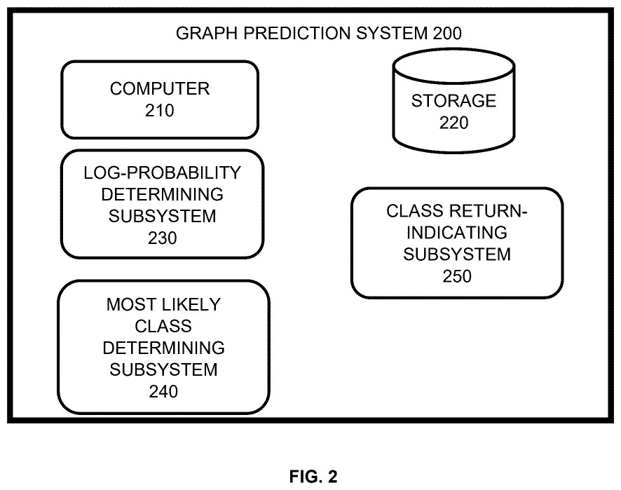

FIG. 2 shows an example graph prediction system 200 in accordance with an embodiment of the subject matter. Graph prediction system 200 is an example of a system implemented as a computer program on one or more computers in one or more locations (shown collectively as computer 210), with one or more storage devices (shown collectively as storage 220), in which the systems, components, and techniques described below can be implemented.

During operation, graph prediction system 200 determines a log probability with log-probability determining subsystem 230. Log-probability determining subsystem 230 determines for every o∈O the expression l(o)+l(xᵢ|o)+Σ_{j∈n(i)}l(e_{i,j}|xᵢ, xⱼ, o), where l(o) is the log of the probability of o, k is the number of nodes in the graph, l(xᵢ|o) is the log of the probability of xᵢ given o, n(i) is the set of neighbors of node i, and l(e_{i,j}|xᵢ, xⱼ, o) is the log of the probability of a (directed) edge e_{i,j} given xᵢ, xⱼ, and o.

Next, graph prediction system 200 determines a most likely class with most likely class determining subsystem 240. Specifically, most likely class determining subsystem 240 determines an o∈O that maximizes the previously determined expression l(o)+l(xᵢ|o)+Σ_{j∈n(i)}l(e_{i,j}|xᵢ, xⱼ, o).

Subsequently, graph prediction system 200 returns a result that indicates the o∈O that maximizes the previously determined expression l(o)+l(xᵢ|o)+Σ_{j∈n(i)}l(e_{i,j}|xᵢ, xⱼ, o) with class return indicating subsystem 250. Graph prediction system 200 thus returns a result that indicates the most likely class for the i^{th} node in a graph.

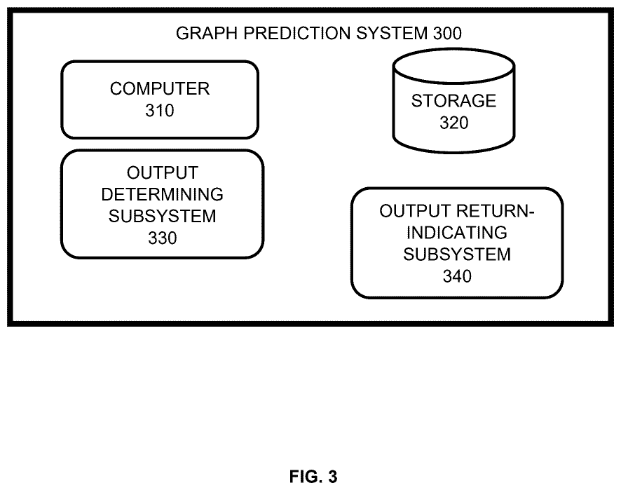

FIG. 3 shows an example graph prediction system 300 in accordance with an embodiment of the subject matter. Graph prediction system 300 is an example of a system implemented as a computer program on one or more computers in one or more locations (shown collectively as computer 310), with one or more storage devices (shown collectively as storage 320), in which the systems, components, and techniques described below can be implemented.

During operation, graph prediction system 300 determines an output with output determining subsystem 330. Output determining subsystem 330 determines the output based on the expression

$$- {( S + {\sum }_{i = 1}^{k} [ {\dot{A}}^{T} \dot{S} \dot{A} + {\sum }_{j ∈ n ( i )} {\ddot{A}}^{T} \ddot{S} \ddot{A} ] )}^{- 1} ( S B + {\sum }_{i = 1}^{k} [ {\dot{A}}^{T} \dot{S} \dot{B} + {\sum }_{j ∈ n ( i )} {\ddot{A}}^{T} \ddot{S} \ddot{B} ] ) ,$$

as defined above for graph regression. Next, graph prediction system 300 returns a result indicating the output with output return-result indicating subsystem 340.

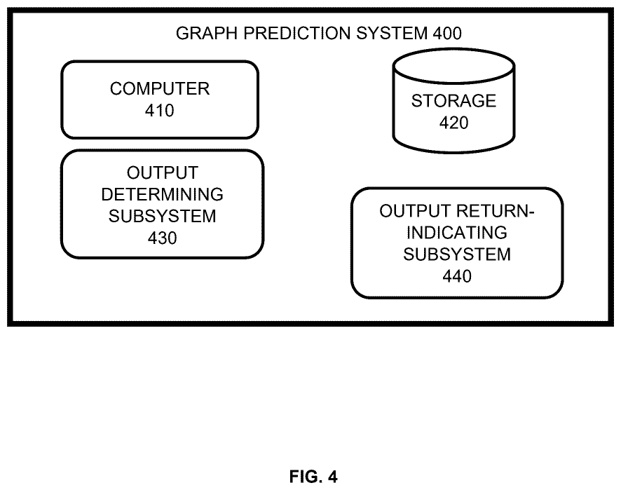

FIG. 4 shows an example graph prediction system 400 in accordance with an embodiment of the subject matter. Graph prediction system 400 is an example of a system implemented as a computer program on one or more computers in one or more locations (shown collectively as computer 410), with one or more storage devices (shown collectively as storage 420), in which the systems, components, and techniques described below can be implemented.

During operation, graph prediction system 400 determines an output with output determining subsystem 430. Output determining subsystem 430 determines the output based on the expression −(S+[\dot{A}^{T}\dot{S}\dot{A}+Σ_{j∈n(i)}Ä^{T}\ddot{S}Ä])⁻¹(SB+\dot{A}^{T}\dot{S}\dot{B}+Σ_{j∈n(i)}Ä^{T}\ddot{S}\ddot{B}), as defined above for node regression. Next, graph prediction system 400 returns a result indicating the output with output return-result indicating subsystem 440.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and applications without departing from the spirit and scope of the subject matter. Thus, the subject matter is not limited to the embodiments shown, but is to be accorded the widest scope consistent with the principles and features disclosed herein.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system’ encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions.

The processor and the memory can be supplemented by, or incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

The components of the system can be interconnected by any form or medium of digital data communication, e.g., a communication network. Examples of communication networks include a local area network (“LAN”) and a wide area network (“WAN”), e.g., the Internet.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The foregoing descriptions of embodiments of the subject matter have been presented only for purposes of illustration and description. They are not intended to be exhaustive or to limit the subject matter to the forms disclosed. Accordingly, many modifications and variations will be apparent to practitioners skilled in the art. Additionally, the above disclosure is not intended to limit the subject matter. The scope of the subject matter is defined by the appended claims.

What is claimed is:

1. A computer-implemented method for facilitating prediction on a graph, comprising:
determining an output o based on the expression
$$- {( S + {\sum }_{i = 1}^{k} [ {\dot{A}}^{T} \dot{S} \dot{A} + {\sum }_{j ∈ n ( i )} {\ddot{A}}^{T} \ddot{S} \ddot{A} ] )}^{- 1} ( S B + {\sum }_{i = 1}^{k} [ {\dot{A}}^{T} \dot{S} \dot{B} + {\sum }_{j ∈ n ( i )} {\ddot{A}}^{T} \ddot{S} \ddot{B} ] ) ,$$
wherein
$$S = {\sum }^{- 1} ,$$
$$B = - μ ,$$
$$\dot{A} = - {\dot{\sum }}_{c} {\dot{\sum }}_{b}^{- 1} ,$$
$$\dot{B} = {x}_{i} - [ {\dot{μ}}_{a} - {\dot{\sum }}_{c} {\dot{\sum }}_{b}^{- 1} {\dot{μ}}_{b} ] ,$$
$$\dot{S} = {( {\dot{\sum }}_{a} - {\dot{\sum }}_{c} {\dot{\sum }}_{b}^{- 1} {\dot{\sum }}_{c}^{T} )}^{- 1} ,$$
$$\ddot{A} = - {( {\ddot{\sum }}_{c} {\ddot{\sum }}_{b}^{- 1} )}^{′} ,$$
$$\ddot{B} = {e}_{i , j} - [ {\ddot{μ}}_{a} + {( {\ddot{\sum }}_{c} {\ddot{\sum }}_{b}^{- 1} )}^{″} [ \begin{matrix}{x}_{i} \\ {x}_{j}\end{matrix} ] - ( {\ddot{\sum }}_{c} {\ddot{\sum }}_{b}^{- 1} ) {μ}_{b} ] ,$$
μ and Σ define a multivariate Gaussian distribution over o,
\dot{μ} and \dot{Σ} define a multivariate Gaussian distribution over
$$[ \begin{matrix}{x}_{i} \\ o\end{matrix} ] ,$$
\ddot{μ} and \ddot{Σ} define a multivariate Gaussian distribution over
$$[ \begin{matrix}{e}_{i , j} \\ {x}_{i} \\ {x}_{j} \\ o\end{matrix} ] ,$$
xᵢ corresponds to information associated with an i^{th} node in the graph,
xⱼ corresponds to information associated with a j^{th} node in the graph,
e_{i,j} corresponds to information associated with a directed edge from the i^{th} node in the graph to a j^{th} node in the graph
\dot{Σ}_{c} is a submatrix of \dot{Σ} associated with a covariance between xᵢ and o,
\dot{Σ}_{b} is a submatrix of \dot{Σ} associated with a covariance of o,
\dot{Σ}ₐ is a submatrix of \dot{Σ} associated with a covariance of xᵢ,
\ddot{Σ}_{c} is a submatrix of \ddot{Σ} associated with a covariance between e_{i,j} and
$$[ \begin{matrix}{x}_{i} \\ {x}_{j} \\ o\end{matrix} ] ,$$
\ddot{Σ}_{b} is a submatrix of \ddot{Σ} associated with a covariance of
$$[ \begin{matrix}{x}_{i} \\ {x}_{j} \\ o\end{matrix} ] ,$$
\ddot{Σ}ₐ is a submatrix of \ddot{Σ} associated with a covariance of e_{i,j},
\dot{μ}_{b} is a subvector of \dot{μ} associated with a mean of o,
\dot{μ}ₐ is a subvector of \dot{μ} associated with a mean of xᵢ,
\ddot{μ}_{b} is a subvector of \ddot{μ} associated with a mean of
$$[ \begin{matrix}{x}_{i} \\ {x}_{j} \\ o\end{matrix} ] ,$$
\ddot{μ}ₐ is a subvector of \ddot{μ} associated with a mean of e_{i,j},
$${( {\ddot{\sum }}_{c} {\ddot{\sum }}_{b}^{- 1} )}^{′}$$
is a submatrix of
$${\ddot{\sum }}_{c} {\ddot{\sum }}_{b}^{- 1}$$
associated with o but not
$$[ \begin{matrix}{x}_{i} \\ {x}_{j}\end{matrix} ] ,$$
and
$${( {\ddot{\sum }}_{c} {\ddot{\sum }}_{b}^{- 1} )}^{″}$$
is a submatrix of
$${\ddot{\sum }}_{c} {\ddot{\sum }}_{b}^{- 1}$$
associated with
$$[ \begin{matrix}{x}_{i} \\ {x}_{j}\end{matrix} ] ,$$
but not o; and returning a result indicating the output.

2. The method of claim 1,
wherein μ, Σ, \dot{μ}, \dot{Σ}, \ddot{μ}, \ddot{Σ} are learned from training data, and
wherein each row of the training data corresponds to a graph and its associated output.

3. One or more non-transitory computer-readable storage media storing instructions that when executed by one or more computers cause the one or more computers to perform operations for facilitating prediction on a graph, comprising:
determining an output o based on the expression
$$- {( S + {\sum }_{i = 1}^{k} [ {\dot{A}}^{T} \dot{S} \dot{A} + {\sum }_{j ∈ n ( i )} {\ddot{A}}^{T} \ddot{S} \ddot{A} ] )}^{- 1} ( SB + {\sum }_{i = 1}^{k} [ {\dot{A}}^{T} \dot{S} \dot{A} + {\sum }_{j ∈ n ( i )} {\ddot{A}}^{T} \ddot{S} \ddot{B} ] ) ,$$
wherein
$$\begin{matrix}s = {\sum }^{- 1} 1 \\ B = - μ , \\ \dot{A} = - {\dot{\sum }}_{c} {\dot{\sum }}_{b}^{- 1} , \\ \dot{B} = {x}_{i} - [ {\dot{μ}}_{a} - {\dot{\sum }}_{c} {\dot{\sum }}_{b}^{- 1} {\dot{μ}}_{b} ] , \\ \dot{S} = {( {\dot{\sum }}_{a} - {\dot{\sum }}_{c} {\dot{\sum }}_{b}^{- 1} {\dot{\sum }}_{c}^{T} )}^{- 1} , \\ \ddot{A} = - {( {\ddot{\sum }}_{c} {\ddot{\sum }}_{b}^{- 1} )}^{′} , \\ \ddot{B} = {e}_{i , j} - [ {μ}_{a} + {( {\ddot{\sum }}_{c} {\ddot{\sum }}_{b}^{- 1} )}^{″} [ \begin{matrix}{x}_{i} \\ {x}_{j}\end{matrix} ] - ( {\ddot{\sum }}_{c} {\ddot{\sum }}_{b}^{- 1} ) {μ}_{b} ] ,\end{matrix}$$
μ and Σ define a multivariate Gaussian distribution over o,
\dot{μ} and \dot{Σ} define a multivariate Gaussian distribution over
$$[ \begin{matrix}{x}_{i} \\ 0\end{matrix} ] ,$$
\ddot{μ} and \ddot{Σ} define a multivariate Gaussian distribution over
$$[ \begin{matrix}{e}_{i , j} \\ {x}_{i} \\ {x}_{j} \\ o\end{matrix} ] ,$$
xᵢ corresponds to information associated with an i^{th} node in the graph,
xⱼ corresponds to information associated with a j^{th} node in the graph,
e_{i,j} corresponds to information associated with a directed edge from the i^{th} node in the graph to a j^{th} node in the graph
\dot{Σ}_{c} is a submatrix of \dot{Σ} associated with a covariance between xᵢ and o,
\dot{Σ}_{b} is a submatrix of \dot{Σ} associated with a covariance of o,
\dot{Σ}ₐ is a submatrix of \dot{Σ} associated with a covariance of xᵢ,
\ddot{Σ}_{c} is a submatrix of \ddot{Σ} associated with a covariance between e_{i,j} and
$$[ \begin{matrix}{x}_{i} \\ {x}_{j} \\ o\end{matrix} ] ,$$
\ddot{Σ}_{b} is a submatrix of \ddot{Σ} associated with a covariance of
$$[ \begin{matrix}{x}_{i} \\ {x}_{j} \\ o\end{matrix} ] ,$$
\ddot{Σ}ₐ is a submatrix of \ddot{Σ} associated with a covariance of e_{i,j},
\dot{μ}_{b} is a subvector of \dot{μ} associated with a mean of o,
\dot{μ}ₐ is a subvector of \dot{μ} associated with a mean of xᵢ,
\ddot{μ}_{b} is a subvector of \ddot{μ} associated with a mean of
$$[ \begin{matrix}{x}_{i} \\ {x}_{j} \\ o\end{matrix} ] ,$$
\ddot{μ}ₐ is a subvector of \ddot{μ} associated with a mean of e_{i,j},
$${( {\ddot{\sum }}_{c} {\ddot{\sum }}_{b}^{- 1} )}^{′}$$
is a submatrix of
$${\ddot{\sum }}_{c} {\ddot{\sum }}_{b}^{- 1}$$
associated with o but not
$$[ \begin{matrix}{x}_{i} \\ {x}_{j}\end{matrix} ] ,$$
and
$${( {\ddot{\sum }}_{c} {\ddot{\sum }}_{b}^{- 1} )}^{″}$$
is a submatrix of
$${\ddot{\sum }}_{c} {\ddot{\sum }}_{b}^{- 1}$$
associated with
$$[ \begin{matrix}{x}_{i} \\ {x}_{j}\end{matrix} ]$$
but not o; and returning a result indicating the output.

4. The one or more non-transitory computer-readable storage media of claim 3,
wherein μ, Σ, \dot{μ}, \dot{Σ}, \ddot{μ}, \ddot{Σ} are learned from training data, and
wherein each row of the training data corresponds to a graph and its associated output.

5. A system comprising one or more computers and one or more storage devices storing instructions that when executed by the one or more computers cause the one or more computers to perform operations for prediction on a graph, comprising:
determining an output o based on the expression
$$- {( S + {\sum }_{i = 1}^{k} [ {\dot{A}}^{T} \dot{S} \dot{A} + {\sum }_{j ∈ n ( i )} {\ddot{A}}^{T} \ddot{S} \ddot{A} ] )}^{- 1} ( S B + {\sum }_{i = 1}^{k} [ {\dot{A}}^{T} \dot{S} \dot{B} + {\sum }_{j ∈ n ( i )} {\ddot{A}}^{T} \ddot{S} \ddot{B} ] ) ,$$
wherein
$$S = {\sum }^{- 1} ,$$
$$B = - μ ,$$
$$\dot{A} = - {\dot{\sum }}_{c} {\dot{\sum }}_{b}^{- 1} ,$$
$$\dot{B} = {x}_{i} - [ {\dot{μ}}_{a} - {\dot{\sum }}_{c} {\dot{\sum }}_{b}^{- 1} {\dot{μ}}_{b} ] ,$$
$$\dot{S} = {( {\dot{\sum }}_{a} - {\dot{\sum }}_{c} {\dot{\sum }}_{b}^{- 1} {\dot{\sum }}_{c}^{T} )}^{- 1} ,$$
$$\ddot{A} = - {( {\ddot{\sum }}_{c} {\ddot{\sum }}_{b}^{- 1} )}^{′} ,$$
$$\ddot{B} = {e}_{i , j} - [ {\ddot{μ}}_{a} + {( {\ddot{\sum }}_{c} {\ddot{\sum }}_{b}^{- 1} )}^{″} [ \begin{matrix}{x}_{i} \\ {x}_{j}\end{matrix} ] - ( {\ddot{\sum }}_{c} {\ddot{\sum }}_{b}^{- 1} ) {μ}_{b} ] ,$$
μ and Σ define a multivariate Gaussian distribution over o,
\dot{μ} and \dot{Σ} define a multivariate Gaussian distribution over
$$[ \begin{matrix}{x}_{i} \\ o\end{matrix} ] ,$$
\ddot{μ} and \ddot{Σ} define a multivariate Gaussian distribution over
$$[ \begin{matrix}{e}_{i , j} \\ {x}_{i} \\ {x}_{j} \\ o\end{matrix} ] ,$$
xᵢ corresponds to information associated with an i^{th} node in the graph,
xⱼ corresponds to information associated with a j^{th} node in the graph,
e_{i,j} corresponds to information associated with a directed edge from the i^{th} node in the graph to a j^{th} node in the graph
\dot{Σ}_{c} is a submatrix of \dot{Σ} associated with a covariance between xᵢ and o,
\dot{Σ}_{b} is a submatrix of \dot{Σ} associated with a covariance of o,
\dot{Σ}ₐ is a submatrix of \dot{Σ} associated with a covariance of xᵢ,
\ddot{Σ}_{c} is a submatrix of \ddot{Σ} associated with a covariance between e_{i,j} and
$$[ \begin{matrix}{x}_{i} \\ {x}_{j} \\ o\end{matrix} ] ,$$
\ddot{Σ}_{b} is a submatrix of \ddot{Σ} associated with a covariance of
$$[ \begin{matrix}{x}_{i} \\ {x}_{j} \\ o\end{matrix} ] ,$$
\ddot{Σ}ₐ is a submatrix of \ddot{Σ} associated with a covariance of e_{i,j},
\dot{μ}_{b} is a subvector of \dot{μ} associated with a mean of o,
\dot{μ}ₐ is a subvector of \dot{μ} associated with a mean of xᵢ,
\ddot{μ}_{b} is a subvector of \ddot{μ} associated with a mean of
$$[ \begin{matrix}{x}_{i} \\ {x}_{j} \\ o\end{matrix} ] ,$$
\ddot{μ}ₐ is a subvector of \ddot{μ} associated with a mean of e_{i,j},
$${( {\ddot{\sum }}_{c} {\ddot{\sum }}_{b}^{- 1} )}^{′}$$
is a submatrix of
$${\ddot{\sum }}_{c} {\ddot{\sum }}_{b}^{- 1}$$
associated with o but not
$$[ \begin{matrix}{x}_{i} \\ {x}_{j}\end{matrix} ] ,$$
and
$${( {\ddot{\sum }}_{c} {\ddot{\sum }}_{b}^{- 1} )}^{″}$$
is a submatrix of
$${\ddot{\sum }}_{c} {\ddot{\sum }}_{b}^{- 1}$$
associated with
$$[ \begin{matrix}{x}_{i} \\ {x}_{j}\end{matrix} ]$$
but not o; and returning a result indicating the output.

6. The system of claim 5,
wherein μ, Σ, \dot{μ}, \dot{Σ}, \ddot{μ}, \ddot{Σ} are learned from training data, and
wherein each row of the training data corresponds to a graph and its associated output.
